(19) United States
(12) Patent Application Publication
(10) Pub. No.: US 2007/0299698 A1
(43) Pub. Date: Dec. 27, 2007

(54) Systems and methods for optimizing a health benefits process

(76) Inventors: Sudhir Anandarao, Vienna, VA (US); James W. Benefiel, Ashburn, VA (US); Sreedhar V. Potarazu, Potomac, MD (US)

Correspondence Address: COOLEY GODWARD KRONISH LLP;ATTN: PATENT GROUP, Suite 1100, 777 - 6th Street, NW, WASHINGTON, DC, 20001, US

(21) Appl. No.: 11/443,457

(22) Filed: May 31, 2006

(51) Int. Cl. G06Q 40/00

(52) U.S. Cl. 705/4

(57) ABSTRACT

The invention includes in one embodiment a method including receiving data associated with a health benefits plan of an entity. A report is automatically transmitted to the entity at a predetermined time associated with a repetitive business practice within a benefits cycle of the entity based on the data received. The report is associated with at least one feature of the health benefits plan of the entity. The method can also include receiving data associated with the health benefits plan of the entity associated with a second time interval or second entity, and automatically transmitting a report based on that data to the entity at a second predetermined time associated with the benefits cycle of the entity. The benefits cycle can be for, example, annual, monthly, quarterly, etc.

### BACKGROUND

The invention relates generally to management of a health benefits process, and more particularly to systems and methods for managing and reporting strategic information related to an entity's health benefits program.

In a typical health benefits program, benefit managers follow repetitive processes (e.g. enrollment, budgeting, plan renewal, etc.) as they manage certain issues during specific points of an annual benefits cycle. Multiple benefits (e.g. medical, pharmacy, dental, vision, disability, and workers compensation, etc.) and programs (disease management, care management, wellness) that are administered by various vendors may be managed at various time periods throughout a benefits cycle. Often, it is difficult to receive information from vendors and/or benefit providers in a timely manner, and at a desired point in time to provide a strategic advantage to the entity.

When questions arise at a specific point in an annual benefit cycle, few choices exist to obtain actionable intelligence or data-driven analysis that can aid the benefit manager in making informed decisions. Typically, an entity can engage a consultant to retrieve and analyze information, and/or seek out information from each of multiple benefit vendors, and/or assign an internal staff member to produce and analyze the data. Unfortunately, each of these choices involves undesirable time and cost implications. For routine issues, certain time lags may be acceptable and the costs predictable. But in circumstances that are unique or more complex, the impact may hinge on the speed and accuracy of response.

Thus, a need exists for a business intelligence system and method that provides analytics regarding both routine issues and exceptions, and that automatically analyzes and transmits reports to decision makers within an entity at one or more predetermined time periods associated with the entity's business practices.

### SUMMARY OF THE INVENTION

The invention includes receiving data associated with a health benefits plan of an entity. A report is automatically transmitted to the entity at a predetermined time associated with a repetitive business practice within a benefits cycle of the entity based on the data received. The report is associated with at least one feature of the health benefits plan of the entity. In some embodiments, the method includes receiving data associated with the health benefits plan of the entity associated with a second time interval, and automatically transmitting a report based on that data to the entity at a second predetermined time associated with the benefits cycle of the entity. The benefits cycle can be annual, monthly, quarterly, etc.

### BRIEF DESCRIPTION OF THE DRAWINGS

The invention is described with reference to the accompanying drawings.

FIG. 1 is a chart illustrating examples of tasks and processes and corresponding data and reports that can be provided according to an embodiment of the invention.

FIG. 2 is a schematic illustration of a system according to an embodiment of the invention.

FIG. 3 is an example of an alert report according to an embodiment of the invention.

FIGS. 4-32 are examples of reports that can be produced and provided according to embodiments of the invention.

FIG. 33 is a flow chart illustrating a method according to an embodiment of the invention.

### DETAILED DESCRIPTION

The methods and systems described herein are implemented utilizing, for example, four primary concepts in connection with various complementary features. First, the system analyzes and addresses repetitive business practices within a health benefits program of an entity. Second, the system scans for opportunities across multiple clients (e.g., health benefits programs for various entities) to identify best practices, and across multiple vendors, for example, to aggregate data. Third, the system provides analysis and reports based on the timing associated with a benefits cycle or financial cycle of an entity. Lastly, the system can use “push” technology to disseminate the analysis and reports. In other words, the analysis and reports are transmitted automatically, without being requested.

As used herein, the term “benefit plan” means a system by which benefits are provided to one or more individuals that are members of the plan. For example, a benefit plan can include a medical plan, a pharmacy plan, a retirement plan, an insurance plan, a pension plan, a workers compensation plan, a disability plan (e.g., short-term or long-term), a dental-care plan (also referred to as a dental plan), a vision-related plan (also referred to as a vision plan), a medical leave plan, a maternity/paternity plan, and/or other similar plan or plans that provide similar types of benefits. Additionally, a benefit plan can include a combination of two or more of the foregoing examples of benefit plans. A benefit plan can be administered, sponsored, or provided by any one or a combination of an employer, an insurance company, a non-profit organization, or other entities having an interest in providing the associated benefits of the benefit plan. Administration, sponsorship and/or provision of a benefit plan can occur by the same entity or different entities. An entity responsible for administering a benefit plan can be referred to generically as an “administering entity” or an “administrating entity.”

As used herein, the term “member” means any individual eligible to receive benefits from a benefit plan. Generally, to be eligible to receive benefits from a benefit plan, a member must be enrolled within (or “under”) that benefit plan, according to the rules of the benefit plan. Members can also be referred to as “beneficiaries,” inasmuch as they receive benefits from the benefit plan. The term “beneficiary” can be somewhat more expansive than “member” as employees are generally eligible to receive workmen's compensation benefits (e.g., after a specified employment period) even though there is no enrollment process, and no benefit plan to select. Members can also be referred to using designations associated with their specific benefit plan. For example, the term “retiree” can be used to describe a member of a retirement plan. A “member population” or “membership” is a group of members eligible to receive benefits from a common benefit plan.

As used herein, the term “claim” refers to a request, or demand, for a benefit, or a payment to a benefit plan provider pursuant to a benefit plan (e.g., a healthcare provider, an insurer, etc.). For example, a claim under a medical benefit plan might be, for example, a claim for payment submitted to the plan sponsor by a physician or other healthcare provider. For example, under a disability benefit plan, a claim may be made by an insurer on behalf of a plan member, or directly by the member. A claim can also generally be made when a benefit provider believes it is entitled to payment for services rendered to a plan member under the benefit plan.

Each of the four primary concepts mentioned above is described below in more detail. The following description describes how the invention can be implemented for use by an entity in the management of various components of a health benefits program. The description describes example embodiments, including example analysis and reports, however, the invention can include other embodiments not specifically described.

### Concept 1: Repetitive Business Practices

Through many aspects of the discrete and integrated workflows that are involved in total health benefits management, the systems and methods provided herein provide proactive analysis in each of the following respective health benefit areas to identify areas of financial risk and opportunities to improve the quality of care. In one example, the system provides analysis and reports, for example, by type of benefit, of the following health benefit areas:

| | | Financial |
|---|---|---|
| Plan Management | Vendor Management | Management |
| Identify trends and outliers | Look for measures of effectiveness | Fairly and fully record the |
| responsive to plan benefit design | to compare Vendors, and | estimates of costs for the |
| | consider Provider or Vendor | company's internal and external |
| | improvements or replacements | constituents |
| Monitor trends in | Evaluate geographic | Maintain dashboards of |
| Enrollment and estimate | coverage and access | high-level trends |
| gross financial impact | Calculate unit cost, | Monitor incurred costs, |
| Monitor access, to prevent | adjusted for illness burden | estimates of completed |
| future increased | Normalize delivery of | costs, and reserves |
| intensities/maintain a | services (Use) for illness | Determine appropriate |
| basic level of population | burden, then analyze for | chargeback to business |
| health | inefficiencies, abuse, and | units, accounts, and |
| Look for opportunities to | fraud (look for lower cost | activities (incl. retirees, |
| promote low-cost venues | treatments/ | unions) |
| Price employee premiums | venues/providers) | Support audit activities |
| (incl. tiers) | Identify compliance to | and fraud/abuse |
| | established or widely | investigations |
| | agreed upon “best | Support planning, |
| | practice” protocols | budgeting, and |
| | | forecasting |

### Within this overall construct, the system can analyze various processes within each of these areas and identify relevant repetitive business practices.

First, for the Plan Management area, the system can, for example, identify and perform the following analytics:
Enrollment Migration Analytics—estimates the financial impact of member movement among vendors, option types, or plan options as a result of new employer offerings.
Medical Plan Analytics—identifies opportunities to reduce unnecessary costs and utilization for emergency room visits and out of network services.
Pharmacy Plan Analytics—evaluates savings opportunities based on formulary versus non-formulary, generic versus brand, and mail-order versus retail.
Dental Plan Analytics—trends dental costs and utilization across plans.
Vision Plan Analytics—illustrates vision costs and utilization across vision plan membership.
Disability Plan Analytics—identifies opportunities to reduce absence and promote return to work.
Workers' Compensation Plan Analytics—identifies opportunities to reduce absence and promote workplace safety.
Employee Contribution Analytics—illustrates trends and cost-share differentials across members in medical, pharmacy and dental plans.
Benefit Modeling and Pricing Analytics—models potential changes in plan design and pricing to forecast the impact of enrollment and utilization on employer cost.

For the Vendor Management area the system can identify, for example, the following profiles and analytics:
Health Risk Profile—provides insight on the degree of financial risk associated with a population, cost drivers by service location, gaps in preventive practices, and prediction of future financial risk.
Best Practice Compliance Profile—provides insight on compliance to established or widely agreed upon “best practice” protocols for many high-risk conditions and for selective preventive screening procedures.
Pharmacy Vendor Analytics—arrays comparable pharmacy unit cost of prescriptions.
Disability Vendor Analytics—differentiates the delivery and demand for disability services.
Claims and Enrollment Review—verifies that claims were paid no more than once and were for eligible members.

For the Financial Management area, the system can provide, for example, the following data reports as more specifically described in pending U.S. patent application Ser. No. 11/253,803, entitled “Systems And Methods Of Managing An Expenditure Cycle,” the entire disclosure of which is hereby incorporated by reference:
Claims and Enrollment Review—verifies that claims were paid no more than once and were for eligible members.
Provider Payment Review—shows that all checks paid are supported by clams adjudicated through the vendor's claims processing system.
Vendor Invoice Validation—confirms that all Vendor requests for funds are supported y Vendor healthcare payments.
Fund Release Monitoring—confirms that all fund disbursements made by the employer are reported as received in full by the Vendor.
Employer GL Auditor—confirms that all disbursements made by the Employer to the healthcare Vendor are properly posted to the appropriate General Ledger account.
Process Assurance Manager—provides, at a glance, the overall status of any of the processes monitored by the Financial Risk Management module.
General Ledger Dashboards—packages analytics and forecasts for key performance indicators including employee contributions, plan administration fees, and paid claims.
Business Unit Analytics—determines charge-backs and key performance indicators at the business unit level.
Reserves Calculations—monitors incurred costs and, using three actuarial methods, calculate estimates to complete and reserves.

### Concept 2: Scans Opportunities

In some embodiments, the system can survey opportunities across multiple client databases to find those areas in which a number of client companies exhibit significant potential for improvement. Scanning across multiple clients can help generate a best practices database. Individual entities are typically unable to identify best practices unless they come together for this communal purpose (as in a coalition of health care purchasers), or they purchase best practice metrics from a third-party data aggregator.

Scanning across multiple vendors' data allows for common formats and data treatments to be employed. This ensures consistent reporting metrics at any given time and over a period of time (for trending or subsequent performance monitoring), rather than relying on each individual vendor to prepare an ad hoc report in its own format from its own data. The data obtained can be from members of a network or affiliated in some other manner. In some embodiments, the vendors are not affiliated with one another.

### Concept 3: Timed to a Benefit and/or Finance Cycle

Reports can be automatically delivered to a company at the appropriate time in the company's annual benefit and/or finance cycle so that, for example, the HR, benefits, and/or finance managers or other personnel can initiate appropriate strategies based on the data provided. Individuals participating in health benefits management typically have a repetitive process (e.g., annually, monthly, etc.) as a company proceeds through planning, strategizing, implementing, and reviewing/monitoring of the health plan program. Health plan options for the company's employees and their dependents are typically fixed for 12 months (the “plan year”), at which time they are revised by corporate benefits managers in light of recent results. In some cases, the benefit cycle is for a shorter period of time such as monthly, quarterly, etc., or a longer period of time such as over a two-year period.

As an example, for a typical plan year that follows the calendar year (i.e., runs from January to December), processes that may need to be accomplished during that time period can include, for example:
January: conduct post-enrollment review;
February-March: initiate contingency planning (disease management, care management, wellness);
April-June: evaluate and prioritize savings opportunities;
July-August: revise plan designs and/or initiate new plans/programs;
August-September: re-price plans;
September-October: prepare employee communications;
September-November: prepare budgets; and
October-December: supervise open enrollment.

If a particular plan or benefit cycle runs on other than a calendar year (e.g., July to June), then the timeframes for these processes can shift accordingly. Each of the processes listed above can be further divided into tasks. For example, the process of initiating new plans or programs can include validating savings opportunities, drafting and presenting recommendations to senior management, obtaining authority for initiatives, beginning discussions with potential new vendors, issuing requests for proposals (RFPs), evaluating offers, ranking responses, and negotiating contracts.

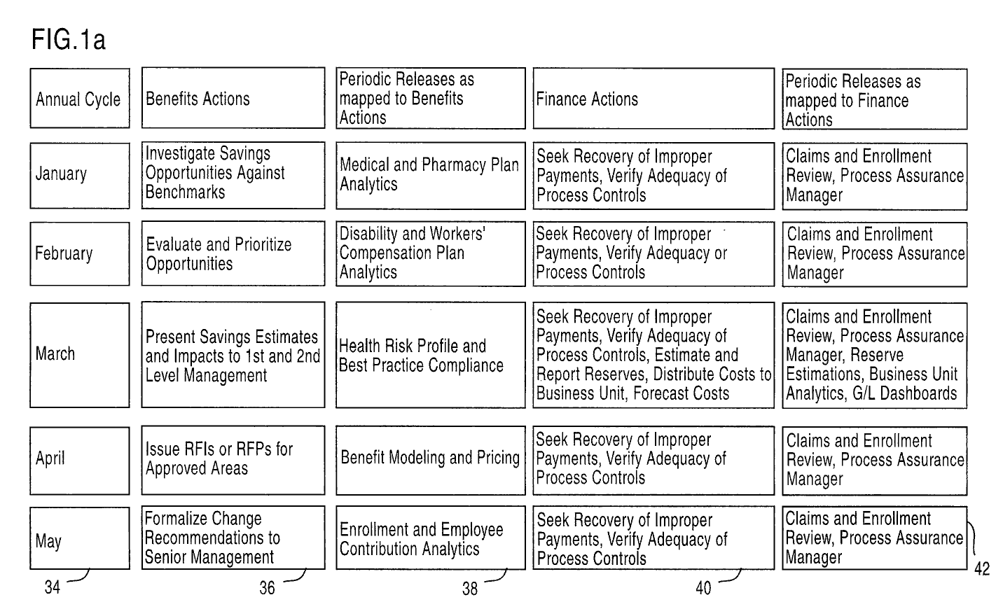

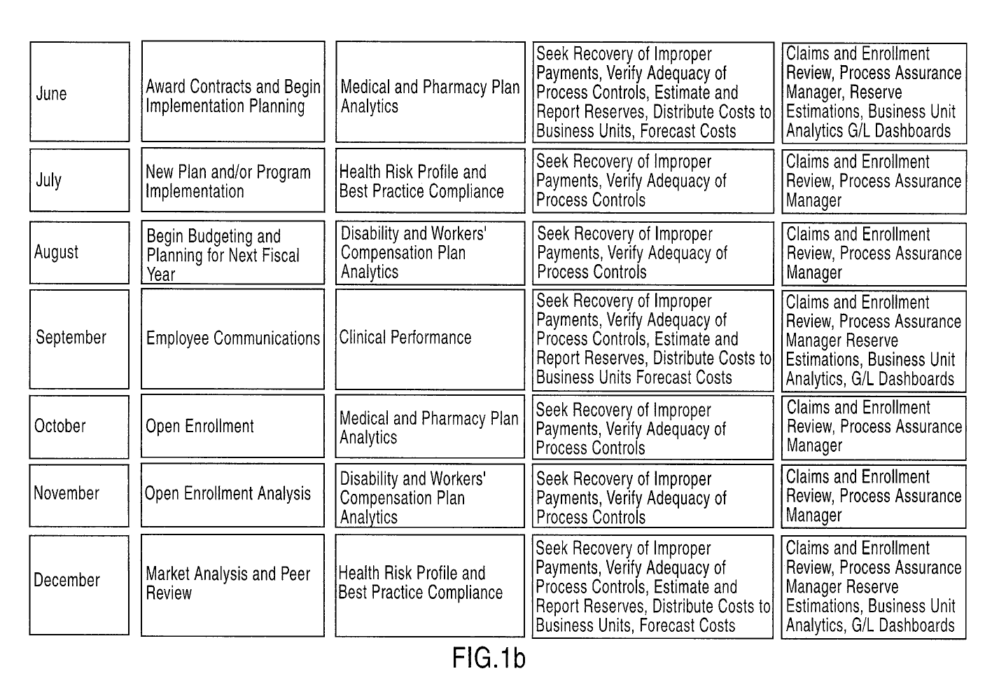

In addition to the periodic tasks and processes cited above, there can be ongoing monitoring activities that ensure that objectives are being met, or that responsible individuals are initiating corrective action. In some embodiments, the system can provide these routine reports as well. FIG. 1 illustrates some examples of tasks and processes and typical corresponding data and reports that can be provided at the appropriate times in a benefits and/or finance cycle. For example, in the month of May, labeled 34, a procedural action within a benefits plan can include “Formalize Change Recommendations to Senior Management,” as indicated at 36. Various analyses can be performed and reports generated on, for example, a monthly basis or release, to aid in such a task or action, and provided, for example, in reports provided by the Enrollment and Employee Contribution Analytics, as indicated at 38. Financial actions can be separately triggered, such as “Seek Recovery of Improper Payments” and “Verify Adequacy of Process Controls” as shown at 40. As mapped to finance actions, various periodic releases can be provided, such as a “Claims and Enrollment Review” and “Process Assurance Manager,” as indicated at 42 in FIG. 1. As shown in FIG. 1, for each month, various reports and analyses can be performed/provided associated with a benefits and/or finance cycle.

### Concept 4: Push Technology

Systems and methods according to various embodiments of the invention can be synchronized with a benefits cycle or financial cycle of an entity. Reports and alerts can be set up to be automatically sent or transmitted to an entity at predetermined time periods associated with a benefit or financial cycle. This helps ensure that information is being provided at time periods when the information may be more useful. Thus, the system can accelerate corporate performance management of health benefits beyond current company practices that typically rely on labor-intensive, time-consuming studies by staff to identify high-priority opportunities. By eliminating costly time lags at the client company (e.g., entity) level for obtaining, aggregating, analyzing, estimating, validating, prioritizing, and modeling key metrics of health benefits strategies, the system can identify for employers realistic cost-savings without the need for the employer to initiate studies. This information can then be automatically analyzed and reported to the entity automatically without the entity requesting the information at the necessary time.

The level of insight that appears in each module typically requires many hours to produce by healthcare experts, as well as some foresight to plan in advance for preparing and delivering the report at the time when it is needed. The system uses the client's own data to automatically identify opportunities and deliver observations and reports without the need for any client intervention. In some embodiments, an application server, e-mail, or other Internet-based services can be used to deliver reports. A report or “alert” can contain a description of what the specific analytic means for the recipient, as well as a measure of impact, in the form of potential savings based on best practices of that company or other companies. Further, the system can direct the user to pre-formatted reports that allow for further investigation (“drill down”) along various dimensions to identify root causes. This adds considerable value, as the user can obtain key metrics in a timely fashion. The user is also provided the context to understand the metric's relevance to each unique situation, and receives direction to obtain further information on the impact of action or delay on the part of the company.

In some embodiments, the system can use the client's/company's enterprise resource planning (ERP) system to identify opportunities and deliver content. Other than benefits enrollment, corporate ERP systems typically do not currently provide the extensibility or reach necessary to effectively manage health benefits. Thus, except for the management of health benefits, nearly every area of the organization can realize advantages directly related to their use of the ERP system. A system according to an embodiment of the invention can be integrated with an ERP system by linking key benefits and finance metrics from the ERP system to external third-party benefits claims information. Therefore, the system can enable clients/companies to leverage their ERP investment to improve performance of the corporate health benefits supply chain. The system can create real time notifications and automated workflow for health benefits management. Health benefits managers can communicate with financial and operational managers and senior executives in the same manner, using similar metrics and measures, and through the same enterprise technology resources, as the rest of the company.

### Implementation

The invention provides methods of manipulating, monitoring and evaluating data associated with a health benefits program. The systems and methods can be embodied in one or more hardware and/or software programs. The methods of the invention are described herein as being embodied in computer programs (software and/or hardware) having code to perform a variety of different functions associated with a health benefits program. It should be understood, however, that the methods are not limited to an electronic medium and can be alternatively practiced in a manual setting. All of the various methods described herein can produce reports and generate screen-shots in a variety of different formats. For example, reports can be generated in tabular format, graphical format, diagrammatical format, or chart format. Reports can be transmitted via a network connection and/or via e-mail using the Internet.

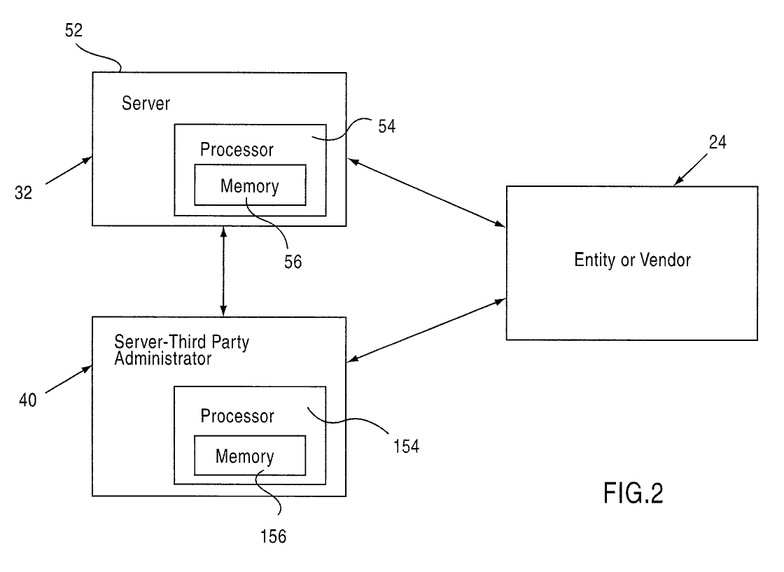

FIG. 2 is a schematic illustration of a system according to an embodiment of the invention. A server 52 according to an embodiment of the invention can be located at an entity's site and/or located such that it is accessible by an entity. Server 52 includes a processor 54. The server 52 can be accessible by an entity and be in communication with one or more entities or vendors via a broadband connection or other high-speed network. The processor 54 can be, for example, a commercially available personal computer, or a less complex computing or processing device that is dedicated to performing one or more specific tasks. For example, the processor 54 can be a terminal dedicated to providing an interactive graphical user interface (GUI). The processor 54, according to one or more embodiments of the invention, can be a commercially available microprocessor. Alternatively, the processor 54 can be an application-specific integrated circuit (ASIC) or a combination of ASICs, which are designed to achieve one or more specific functions, or enable one or more specific devices or applications. In yet another embodiment, the processor 54 can be an analog or digital circuit, or a combination of multiple circuits.

The processor 54 can include a memory component 56. The memory component 56 can include one or more types of memory. For example, the memory component 56 can include a read only memory (ROM) component and a random access memory (RAM) component. The memory component 56 can also include other types of memory that are suitable for storing data in a form retrievable by the processor 54. For example, electronically programmable read only memory (EPROM), erasable electronically programmable read only memory (EEPROM), flash memory, as well as other suitable forms of memory can be included within the memory component 56. The processor 54 can also include a variety of other components, such as for example, co-processors, graphic processors, etc., depending upon the desired functionality of the code.

The processor 54 is in communication with the memory component 56, and can store data in the memory component 56 or retrieve data previously stored in the memory component 56. The components of the processor 54 can communicate with devices external to the processor 54 by way of an input/output (I/O) component (not shown). According to one or more embodiments of the invention, the I/O component can include a variety of suitable communication interfaces. For example, the I/O component can include, for example, wired connections, such as standard serial ports, parallel ports, universal serial bus (USB) ports, S-video ports, local area network (LAN) ports, small computer system interface (SCCI) ports, and so forth. Additionally, the I/O component can include, for example, wireless connections, such as infrared ports, optical ports, Bluetooth® wireless ports, wireless LAN ports, or the like. The network to which the processor 54 is connected can be physically implemented on a wireless or wired network, on leased or dedicated lines, including a virtual private network (VPN).

A system and method of the invention can be accessed and operated by an entity via the server 52, or alternatively by a third party administrator. As shown in FIG. 2, a third-party administrator or server 40 can include a processor 154 (with memory 156) as described above for the server 52 and processor 54. The third-party administrator 40 can, for example, manage and control a health benefits program for one or more entities and act as an intermediary between vendors and entities.

As stated above, in some embodiments, one or more vendors or other entities 24 can be in communication with the server entity and/or third-party administrator. Such an entity or vendor can include a processor as described above, that is in communication with an entity processor (e.g., processor 52) and/or a third-party administrator processor (e.g., processor 154). This allows data and information to be shared between a vendor and the entity and/or third-party administrator. In some embodiments, communications (e.g., reports, transfers of data) between an entity and a server on which a system according to an embodiment of the invention is located, can be via the Internet. In such an embodiment, data and reports can be transmitted between the parties via email, a shared access website, etc.

FIG. 3 illustrates an example report or “alert” generated by a system according to an embodiment of the invention. An alert is a type of report that can include, for example, a description of the specific analytic means for the particular recipient, a measure of the impact of the analytic in the form of potential savings based on best practices, and a link for the user to access pre-formatted reports that allow for further investigation.

Each alert can be supplemented by a selection of reports, and in some cases pre-formatted reports. A report can include, for example, a description of the analytic means, a measure of potential savings, and a link for the user to access pre-formatted reports that allow for further investigation. A report can also address a repetitive business practice within the benefits cycle and can be produced after scanning for opportunities across multiple vendors. Reports can be generated after scanning for opportunities across multiple clients and multiple vendors and then used to identify opportunities to reduce unnecessary cost and/or utilization across several dimensions associated with the benefits, including but not limited to 1) offerings such as vendors, plan types, health plans, or coverage tiers; 2) employment conditions such as business unit, employment status, exempt status, or union affiliation; demographics such as gender, age, or dependency; 3) clinical conditions such as disease, condition group, resource utilization band, illness burden, efficiency index, or predicted risk index; and 4) time interval.

The first set of pre-formatted reports can repeat those shown in an initial alert (e.g., in case the user wishes to select different dates). The subsequent pre-formatted reports can provide the same metrics as the initial alert, but array these metrics across different dimensions (attributes). This allows for further investigation (“drill down”) among several potentially useful dimensions, including, for example:
Employment (e.g., active v. retired, exempt v non-exempt, business unit, region, union, job classification)
Enrollment (e.g., benefit, vendor, option type, plan option, coverage tier, date)
Demographics (e.g., age, gender, dependent status)
Disease/Condition (e.g., member condition group, medical diagnostic category, drug therapeutic category, resource utilization band, co-morbidity ratio, efficiency index, predicted risk)
Venue (e.g., service location, service type, drug distribution channel)

With respect to benefit administration, exercising these pre-formatted reports enables the user to:
pinpoint areas of financial risk,
focus on specific cost drivers,
take immediate corrective action
respond with targeted initiatives, and
achieve cost savings, improve access, or enhanced health status of the covered population.

With respect to the corporate financial function, these pre-formatted reports enable the user to:
enhance internal controls through focusing on those processes not working as expected, and
validate reported results, ensuring the integrity of the health benefits expense reporting, and leverage the employer's clout with its health care vendors, increasing the efficiency of cash utilization and asset management.

Various functional modules according to embodiments of the invention are described below that can be incorporated within a variety of different systems and methods of the invention.

An embodiment of the invention can include one or more Plan Management Modules, which can include, for example, 1) an Enrollment Analytics Module, 2) a Medical Plan Analytics Module, 3) a Pharmacy Plan Analytics Module, 4) a Dental Plan Analytics Module, 5) a Vision Plan Analytics Module, 6) a Disability Plan Analytics Module, 7) a Workers' Compensation Plan Analytics Module, 8) an Employee Contribution Analytics Module, and/or 9) a Benefit Modeling and Pricing Module. Some of these modules are described in more detail below, as well as some example reports that can be provided.

The Enrollment Analytics Module can enable a user to evaluate cost impact and risk implications from shifts and trends in dependent coverage and plan migration. This module can be used to analyze the expected fiscal impact of the elections of members on new benefit plans and new benefit plan offerings, for example, as early as the beginning of a new plan year. A processor including this module can receive electronic data representing information associated with multiple individuals or members enrolled within a health benefits plan during a pre-selected time period and receive electronic data representing information associated with multiple claims under a health benefits plan for the same pre-selected time period. The processor can then automatically search and report on information such as, for example, the net change in enrollment among vendors and/or plans, and/or the anticipated financial impact of such change. The processor can also provide electronic links to allow the user to access the processor and run reports of similar metrics along various pre-determined dimensions with values (“filters”) designated by the user.

In some embodiments, the Enrollment Analytics Module can receive data associated with a change of enrollment for all vendor's offerings of a health benefits plan of the entity. The processor can calculate the change in enrollment and compare recent enrollment changes against long-term trends; identify the demographic changes and clinical conditions in enrollment; identify migration patterns across offerings and employment conditions; and trace such changes to revisions in plan design or pricing. The processor can also estimate a cost impact associated with the change in enrollment along several dimensions associated with the benefits, including but not limited to offerings such as 1) vendors, plan types, health plans, or coverage tiers; 2) employment conditions such as business unit, employment status, exempt status, or union affiliation; 3) demographics such as gender, age, or dependency; and 4) clinical conditions such as disease, condition group, resource utilization band, illness burden, efficiency index, or predicted risk index,

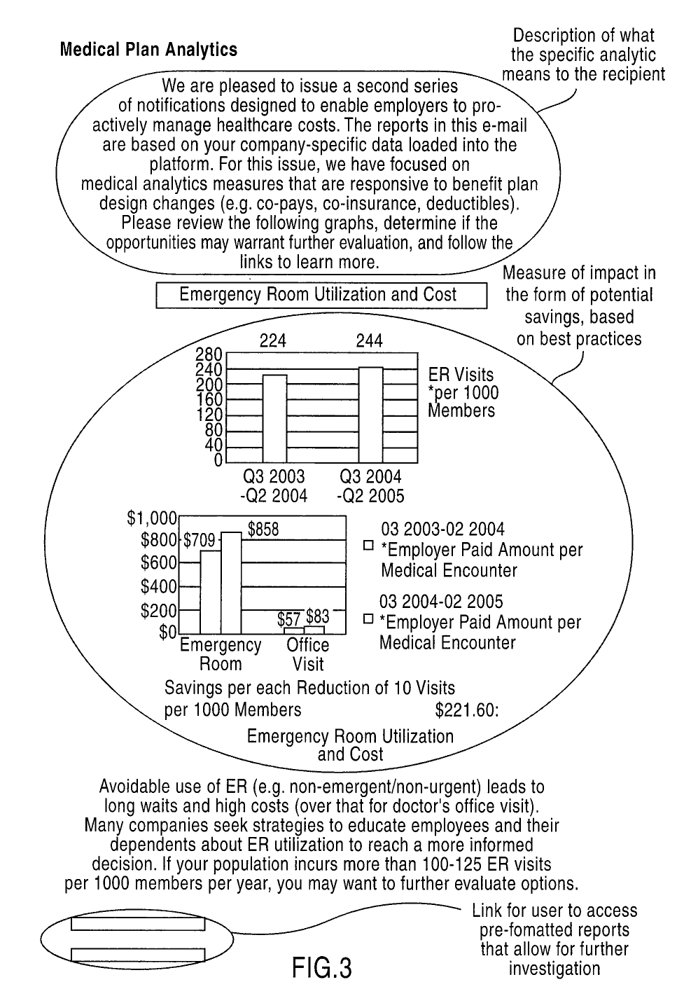

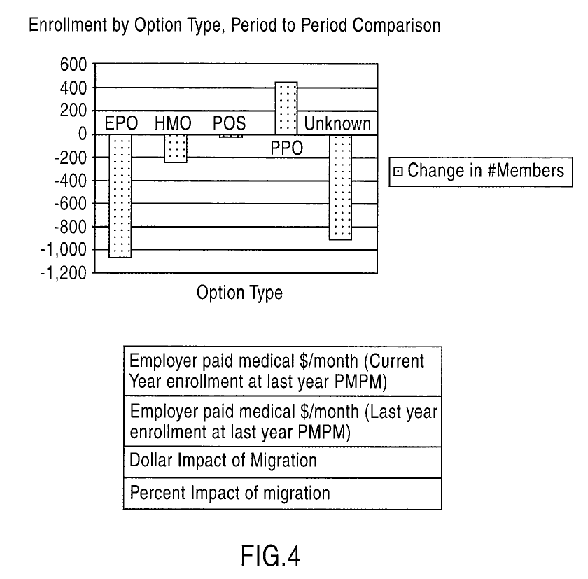

FIG. 4 illustrates an example concept report generated with the Enrollment Analytics Module. This report shows the change in number of members from last year to this year across option types and allows an employer (or other entity) to analyze the impact of plan design and pricing changes from the last plan year. The entity can determine whether the benefit design and pricing changes from last year resulted in enrollees (e.g., members) migrating to lower cost plans and its impact on their overall medical expenditures. The metric “Dollar Impact of Migration” shows the net difference between the current year enrollment versus last year's enrollment, at last year's cost per member per month.

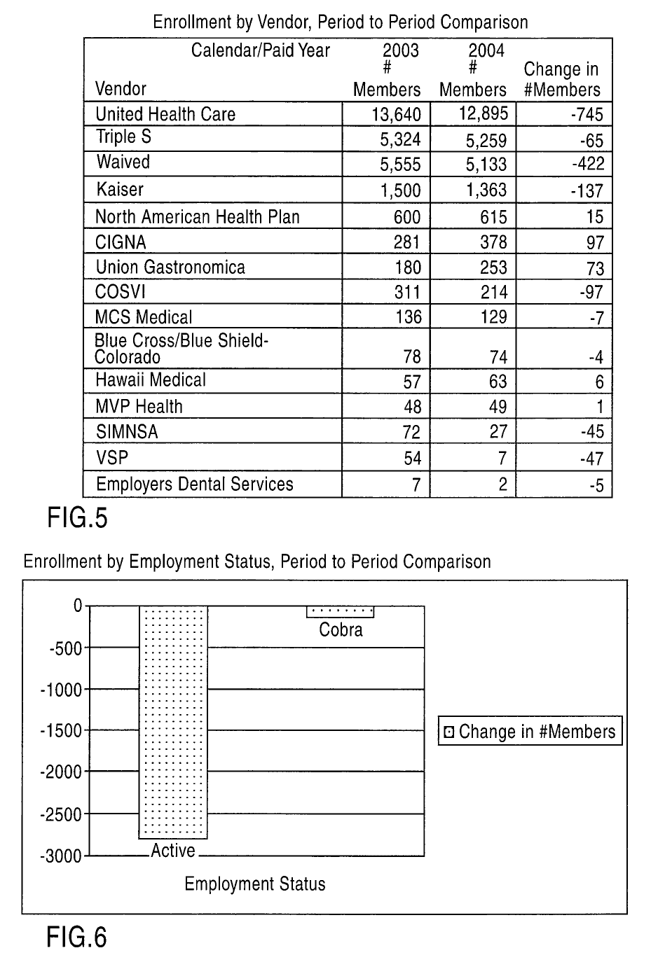

FIG. 5 is an example report showing the change in the number of members from last year to the current year across vendors. An entity can use this report to determine whether the benefit design and pricing changes from last year resulted in enrollees migrating preferentially to certain vendors, and the expected impact on their overall medical expenditures.

FIG. 6 is an example report showing the change in the number of members from last year to this year by employment status. Employment status corresponding to Active, Retired and COBRA are displayed on the graph. Employers can determine whether a change in the relative counts of these members in these categories (i.e., the number of employees taking early retirement) is contributing to an increase in expected healthcare expenditure.

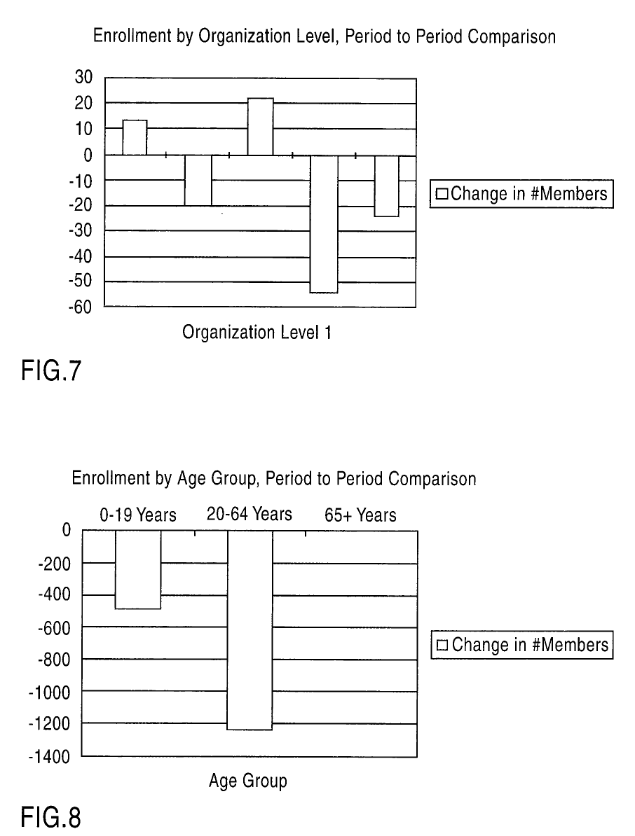

FIG. 7 is an example report showing the change in number of members from last year to this year by organization level. The top 5 organization levels with the highest enrollment in the current year are displayed on the graph. Employers can use the report to determine whether the benefit design and pricing changes from last year resulted in enrollees migrating preferentially to certain plans at the expense of other plans.

FIG. 8 is an example report showing the change in number of members from last year to this year across age groups. Using this report, employers can determine, for example, whether the benefit design and pricing changes from last year resulted in enrollees migrating preferentially to certain plans according to broad categories of age.

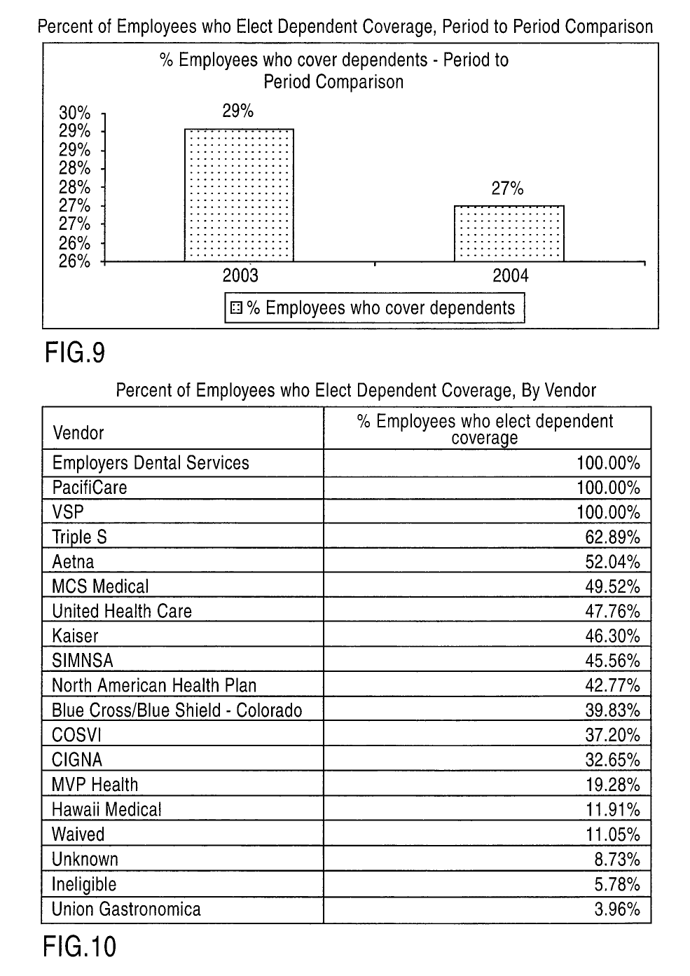

FIG. 9 is an example report showing the trend in the percentage of employees who covered their dependents. This report can be useful, for example, for determining if any changes in unit cost are attributable to migration of employees whose dependents obtained coverage through other means.

FIG. 10 is an example report that shows the percentage of employees who cover their dependents based on the vendor with whom they are enrolled for benefits. This report is designed to assist in identifying those vendors in which a large percentage of employees cover their dependents. Typically, a greater percentage of employees cover their dependents with those vendors where the spousal or family contribution is not large and the demand for services is frequent and predictable (e.g. vision and dental vendors).

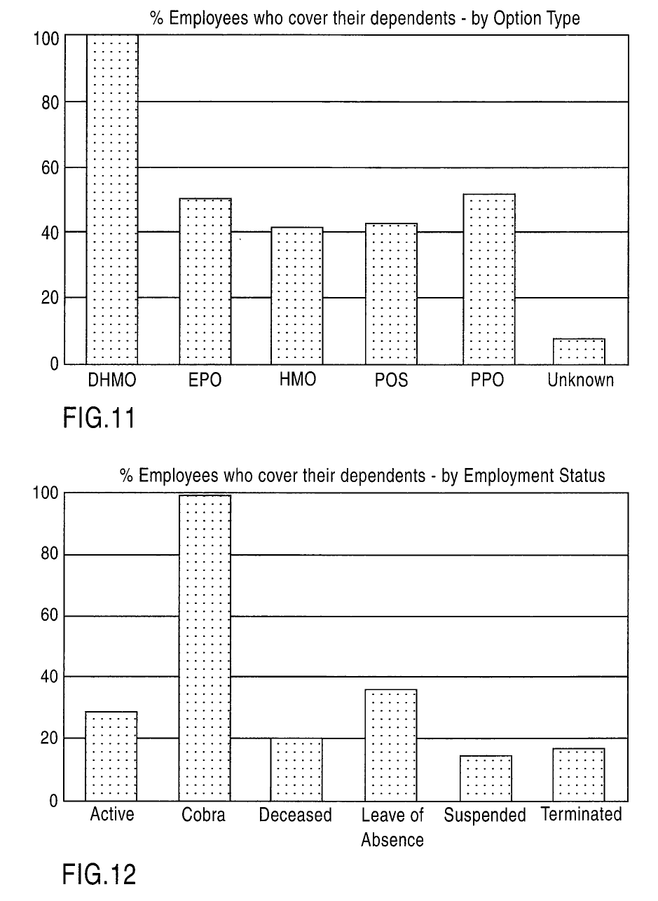

FIG. 11 is an example report that shows the percentage of employees who cover their dependents based on the option type. This report is designed to assist in identifying one or more option types or products that have a high percentage of employees covering their dependents, and/or to estimate the financial impact of migration across the various option types.

FIG. 12 is an example report that shows the percentage of employees who cover their dependents based on their employment status. This report can help assist in determining whether employees with a specific employment status are disproportionately covering their dependents, and thereby contributing to expected changes in healthcare expenditure.

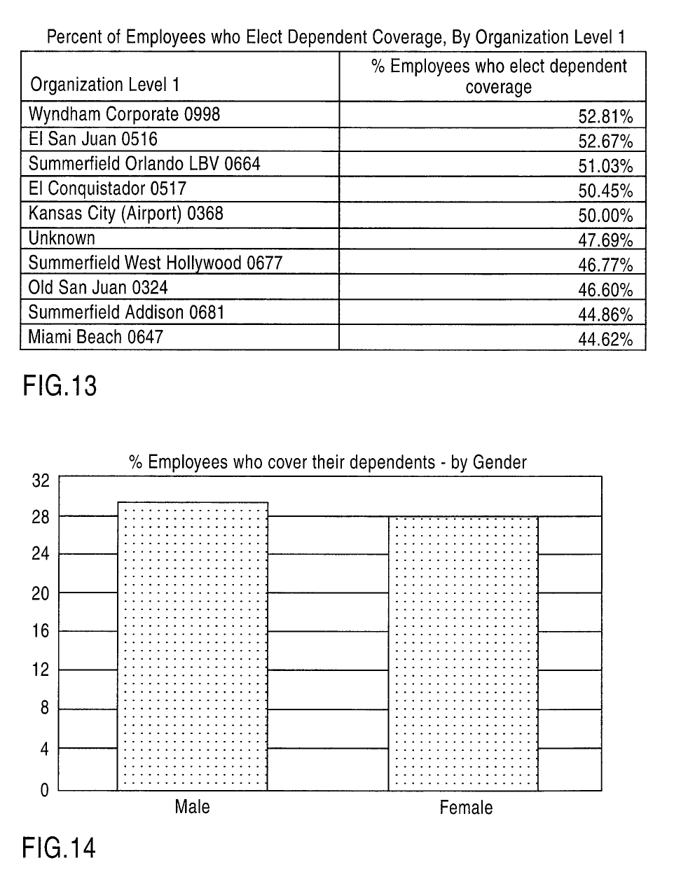

FIG. 13 is an example report that shows the percentage of employees who cover their dependents based on their organization level or business unit. This report is designed to assist in identifying those organization levels having a large percentage of employees that cover their dependents, and/or to estimate the financial impact of migration across these business units.

FIG. 14 is an example report illustrating the portion of male and female employees who cover their respective dependents. Typically, a greater percentage of male employees cover their dependents compared to female employees. This report is useful in determining if changes in plan design or pricing have caused one gender or the other to predominately cover or terminate coverage of dependents. The employer can then estimate the financial impact of such changes.

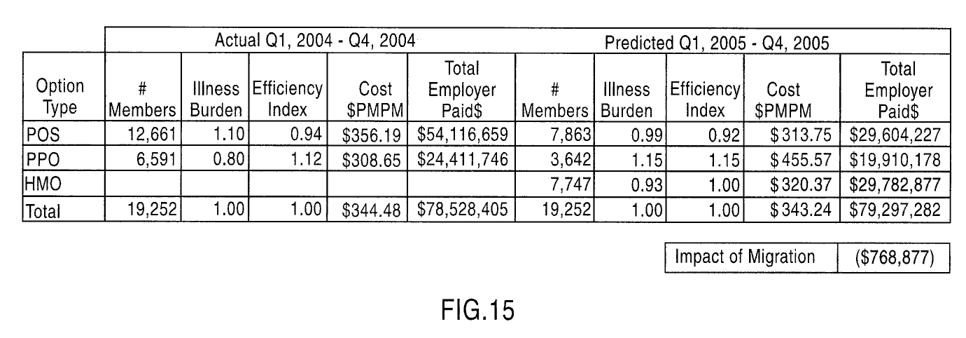

FIG. 15 is an example report that shows the predicted financial impact of members electing new plan coverage at the beginning of a new plan year, on the basis of actual and predicted illness burden and efficiency index of the members and plans involved during the recent open season. With this automatic reporting and alert system, employers can use the information, for example, to forecast the financial impact of members migrating from a previous year (e.g., Year 1) to a current year (e.g., Year 2) across venders, options, and option types based on the illness burden of those members, as soon as the enrollment elections of an open season are finalized.

With the above described automatic analysis, reporting, and alert system, provided by the Enrollment Analytics Module, entities can use the information to, for example:
Compare recent enrollment changes against long-term trends,
Identify the demographic changes in enrollment,
Identify the migration patterns across vendors, plans, or business units,
Trace such changes to changes in plan design or pricing, and
Estimate the expected impact on healthcare expenditure.

A system and method according to an embodiment of the invention can also include the Medical Plan Analytics Module, which can be used to enable a user to identify opportunities to reduce unnecessary costs and utilization of, for example, emergency room visits and/or out of network service. A processor can receive electronic data representing information associated with multiple individuals/members enrolled within a benefit plan during a pre-selected time period and receive electronic data representing information associated with multiple claims under the benefit plan for the same pre-selected time period. The processor can then automatically search and report on information such as, for example, the utilization of medical services at potentially inappropriate venues (e.g., out of plan locations or venues), the opportunity to increase the use of appropriate venues, and the anticipated financial impact of such change(s). The processor can also provide electronic links to the user to access the processor and run reports of similar metrics along various pre-determined dimensions with values (“filters”) designated by the user.

In some embodiments, the Medical Plan Analytics Module can receive data associated with multiple claims submitted under a health benefits plan for an entity and identify at least one claim associated with a non-preferred service or out of network service. The information can be automatically transmitted without being requested at a particular time, for example, via a report to the entity that indicates the utilization of services at non-preferred locations and the cost implications of such services or venues.

This module can also receive data associated with claims associated with services rendered at an emergency venue. The data can be sent to an entity via various reports that can be used to estimate potential excess utilization of the emergency venue, and compare recent utilization against long-term trends. The data can also be used to review the demographic changes and clinical conditions in such utilization; identify patterns across offerings and employment conditions; and trace such change to revisions in plan design or pricing. An entity can use the data provided in the reports to, for example, determine a difference between actual cost of services rendered at emergency venues and an estimated cost of services, if rendered, at an alternative venue. A report can include the actual cost per encounter, the estimated cost per encounter at an alternative venue, and the total cost difference (for example, obtained by multiplying the cost per encounter differences by the amount of excess utilization). A report can also be used to categorize excess utilization and cost impacts of the emergency venue along several dimensions associated with the benefits, including but not limited to offerings such as 1) vendors, plan types, health plans, or coverage tiers; 2) employment conditions such as business unit, employment status, exempt status, or union affiliation; and 3) demographics such as gender, age, or dependency; and clinical conditions such as disease, condition group, resource utilization band, illness burden, efficiency index, or predicted risk index.

In some embodiments, data can be received that is associated with claims associated with services rendered as inpatient hospitalization. Such data can be used to generate reports that can be used, for example, to 1) estimate potential excess utilization of inpatient hospitalization, and compare recent utilization against long-term trends; 2) review the demographic changes and clinical conditions in such utilization; 3) identify patterns across offerings and employment conditions; and 4) trace such change to revisions in plan design or pricing.

An entity can use reports generated that are associated with inpatient hospitalization to determine a difference between actual cost of services rendered with inpatient hospitalization and an estimated cost of services, if rendered, at an alternative venue. A report can include the actual cost per encounter, the estimated cost per encounter at an alternative venue, and the total cost difference (for example, obtained by multiplying the cost per encounter differences by the amount of excess utilization). A report can also categorize excess utilization and cost impacts of inpatient hospitalization along several dimensions associated with the benefits, including but not limited to offerings such as 1) vendors, plan types, health plans, or coverage tiers; 2) employment conditions such as business unit, employment status, exempt status, or union affiliation; and 3) demographics such as gender, age, or dependency; and clinical conditions such as disease, condition group, resource utilization band, illness burden, efficiency index, or predicted risk index.

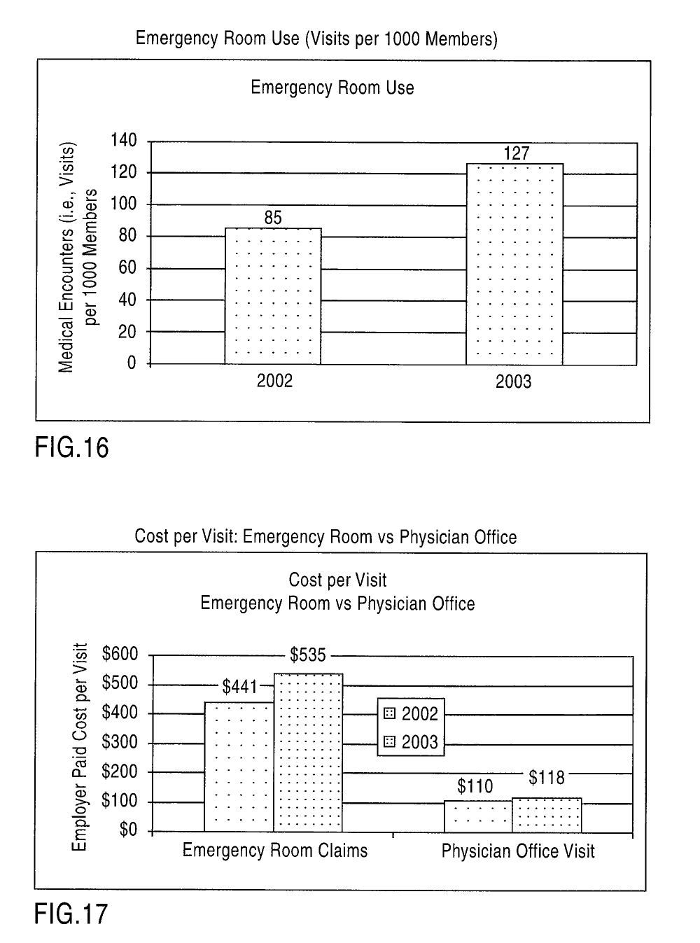

FIG. 16 illustrates an example report that shows emergency room utilization (e.g., visits per 1000 members) for a two year period. This report can be useful in determining if actual trends are the same as what was anticipated or forecasted. FIG. 17 illustrates emergency room utilization and unit costs for a two year period, which can be useful for determining the root cause of significant increases in emergency room cost per member per month. Using these reports, an estimate of the gross savings potential obtainable by shifting inappropriate emergency room use to more appropriate venues can be determined by comparing the emergency room unit cost to the physician office visit unit cost.

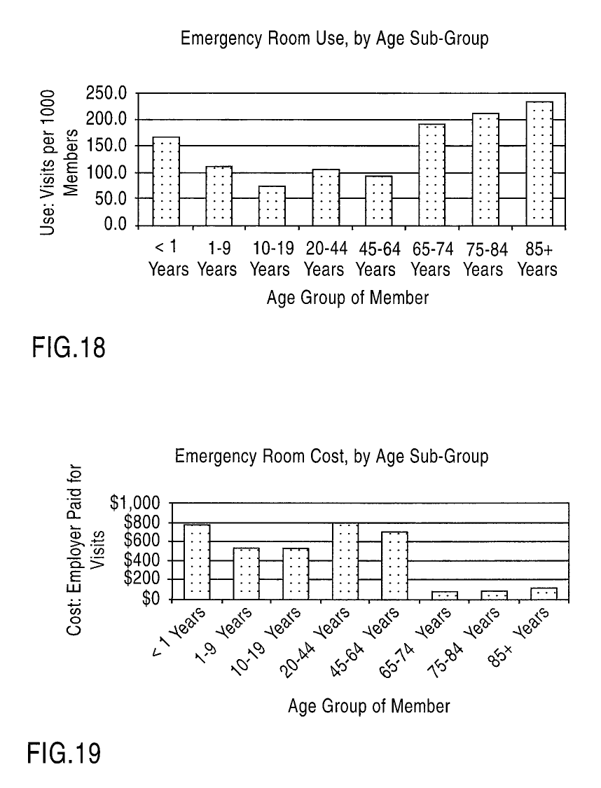

FIGS. 18 and 19 each illustrate reports that show emergency room (ER) utilization and ER cost per visit, respectively, based on pre-defined age sub-groups. These reports can assist in identifying any sub-groups of members that may be incurring high ER use. ER use varies by age (infants and the elderly typically incurring the most), and this report allows the user to determine some of the causes for high ER use, or to determine if certain individuals/members are using the ER as their venue for primary care.

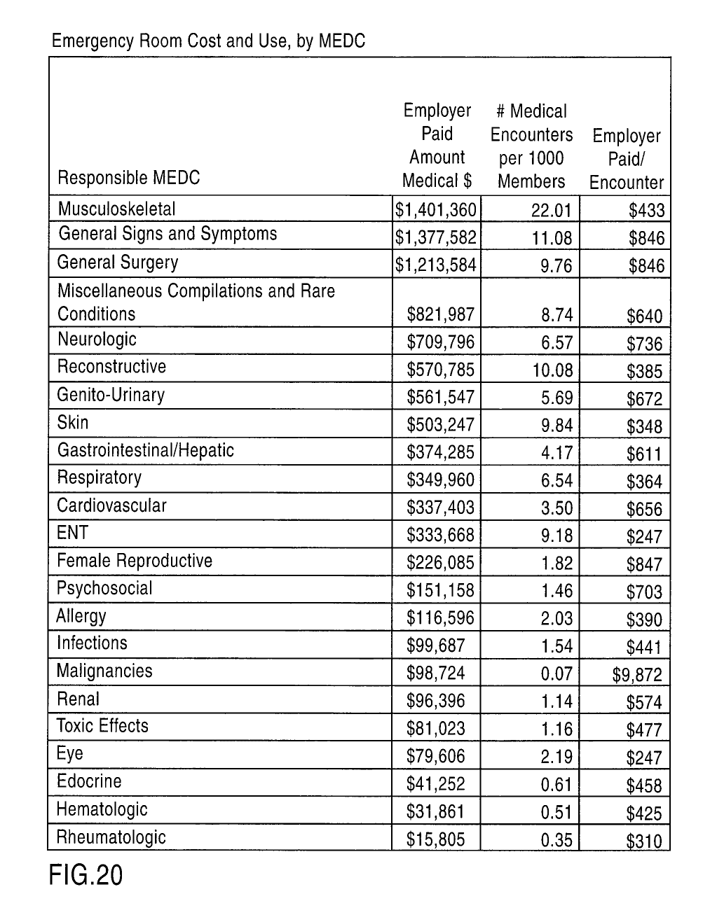

FIG. 20 is an example report that shows emergency room cost and utilization by responsible major expanded diagnosis cluster (MEDC) for those MEDC's having the greatest potential savings achievable through reduced use of the emergency room. emergency room cost and use can also be provided in a report based on the vendor (e.g., health plan), which can be used to assist in the identification of members for specific vendors that are incurring high emergency room cost and use, and to help determine whether any above-average use (e.g., encounters/1000 members) may be due to, for example, such things as, 1) more intense acute episodes than average, 2) employee cost sharing differential between emergency room and either urgent care or physician office being too narrow, or 3) vendor not having an effective program to influence members and physicians to obtain/deliver care via the most appropriate setting (e.g., office visit or urgent care clinic). Emergency cost and utilization can also be reported by organizational level (e.g., sales and manufacturing, operations, etc.), or by employment status (e.g., active, retired).

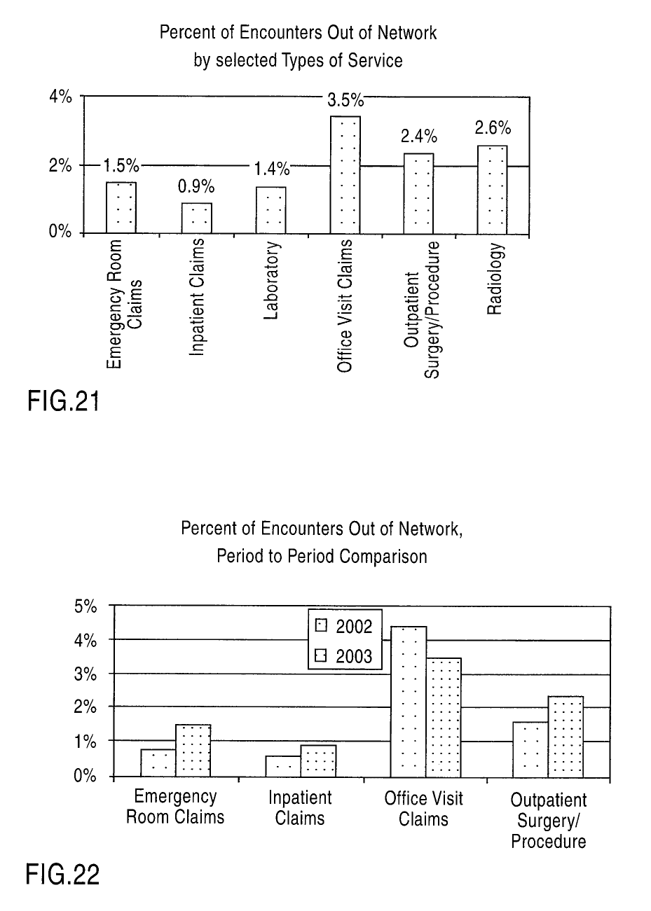

FIG. 21 is an example report that shows out of network (OON) usage (percent of encounters out of network) by selected service location details. This report can assist an employer in determining whether plan benefits are effective in (1) motivating patients to use the network for most encounters, and (2) in holding the employer relatively cost-neutral to the consumer's choice of provider.

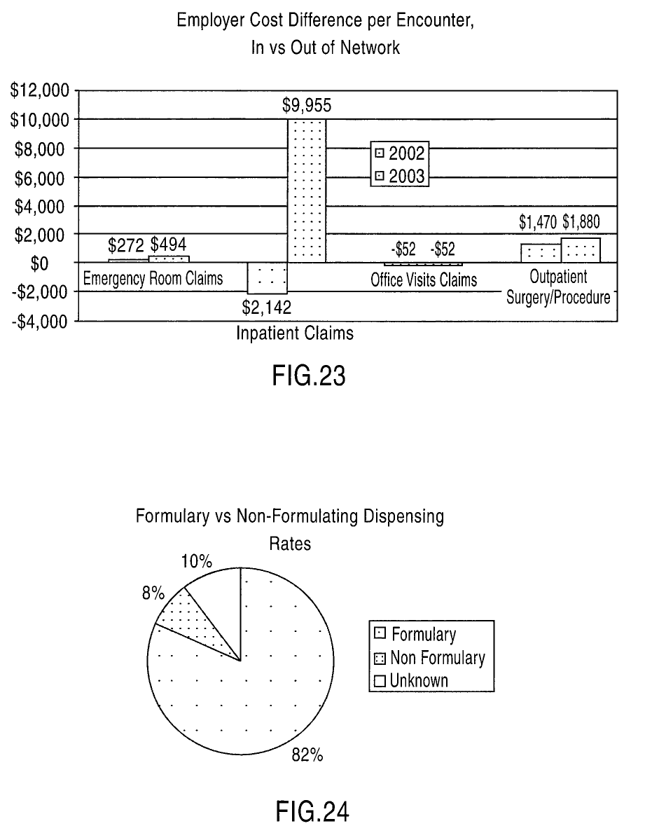

FIG. 22 is an example report that shows out of network usage (percent of encounters out of network), period to period comparison for major service location details. This report can help determine if actual usage has developed as expected or estimated. FIG. 23 is an example report that shows employer cost per encounter for in vs. out of network, by selected service location details. This report can be used to determine if plan sponsors have remained relatively cost-neutral when members opt out of the network, while offering members a wide choice of providers. Other reports can be provided show in vs. out of network usage (percent of encounters out of network) based on such things as age group or relation to the subscriber (e.g., child spouse, etc.). Such reports can assist in identifying if any subset of the general population is responsible for high out-of-network usage or if any specific type of family member is the chief cause of high out of network usage. Reports can also be generated that indicate the in vs. out of network usage (percent of encounters out of network) by MEDC (e.g., musculoskeletal, cardiovascular, neonatal, etc.), by vendor, by type of service (e.g., impatient claim, office visit claim, emergency room claim, etc.), by organizational level, or by employment status (e.g., active, retired).

The Medical Plan Analytics Module's automatic analysis, reporting, and alert system, can provide an employer with information to, for example:
Compare recent emergency room and out-of-network usage against long-term trends,
Identify any demographic factors in ER and OON usage,
Identify the usage patterns across vendors, plans, or business units,
Trace such changes to changes in plan design or pricing,
Identify opportunities to reduce inappropriate ER and OON usage, and/or
Estimate the expected impact on healthcare expenditure.

A system and method according to an embodiment of the invention can also include the Pharmacy Plan Analytics Module, which can be used to enable a user to evaluate savings opportunities based on increasing the use of preferred distribution channels (e.g., formulary versus non-formulary, generic versus brand, and/or mail-order versus retail). A processor can receive electronic data representing information associated with multiple individuals enrolled within benefit plans during a pre-selected time period and receive electronic data representing information associated with multiple claims under a benefit plan for the same pre-selected time period. The processor can then automatically search and report on information such as the utilization of preferred distribution channels compared to non-preferred distribution channels, the opportunity increasing the use of preferred distribution channels, and the anticipated financial impact of such change. The processor can also provide electronic links to the user to access the processor and run reports of similar metrics along various pre-determined dimensions with values (“filters”) designated by the user.

In some embodiments, the Pharmacy Plan Analytics Module can receive data associated with multiple claims associated with prescriptions rendered by a non-preferred pharmaceutical channel (e.g., off-formulary instead of on-formulary, brand instead of generic, or retail instead of mail order, the latter, for example, for refills of maintenance drugs). A report(s) can be automatically generated and transmitted to an entity that provides data on the utilization of services, and cost implications of potentially inappropriate pharmaceutical services.

The entity can use the report(s) and data to estimate potential excess utilization of non-preferred channels, and compare recent utilization against long-term trends. A report(s) can also be used to review the demographic changes and clinical conditions in such utilization; identify patterns across offerings and employment conditions; and trace such change to revisions in plan design or pricing. The entity can use the information to help determine a difference between the actual cost of prescriptions rendered by the non-preferred pharmaceutical channel and an estimated cost of prescriptions, if rendered, by a preferred pharmaceutical channel. A report(s) can include for example, the actual cost per days' supply, the estimated cost per days' supply at a preferred pharmaceutical channel, and the total cost difference (e.g., obtained by multiplying the cost per days' supply differences by the amount of excess utilization). Such report(s) can also be used to categorize excess utilization and cost impacts along several dimensions associated with the benefits, including but not limited to offerings such as 1) vendors, plan designs, health plans, or coverage tiers; 2) employment conditions such as business unit, employment status, exempt status, or union affiliation; and demographics such as gender, age, or dependency; and 3) clinical conditions such as drug therapeutic class, disease, condition group, resource utilization band, illness burden, efficiency index, or predicted risk.

FIG. 24 illustrates an example report that shows formulary vs. non-formulary dispensing rates, which is a measure of formulary compliance. A formulary, for example, contains a list of preferred drugs that are selected based on such things as cost and efficacy. The report enables the user (e.g., entity or employer) to determine if such drugs are being dispensed preferentially. Another report can be provided that compares two periods of formulary vs. non-formulary dispensing rates, which can be used to confirm whether a usage trend is acceptable.

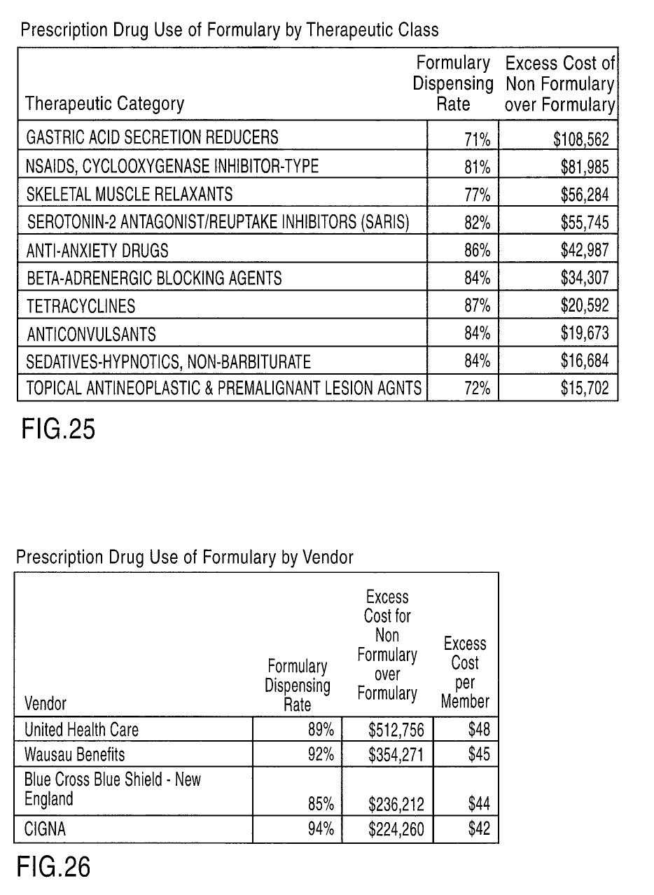

FIG. 25 is an example report that shows potential savings from increased formulary compliance by drug therapeutic category. The column labeled “Excess of Cost” shows a calculated difference in cost between non-formulary and formulary drugs. Other reports can be provided, such as for example, a report that shows the formulary dispensing rate by major practice category (e.g., gastroenterology, cardiology, opthalmology, etc.) MPC for those MPC's having the greatest savings potential achieved by Formulary compliance. This type of report can be used to determine if selected MPC's contribute disproportionately to the excess of cost total.

FIG. 26 is an example report that shows the generic dispensing rate by medical plan vendor, and the potential savings achievable by increased formulary compliance. Another report can be provided that shows the formulary dispensing rate by business unit (e.g., manufacturing, sales and marketing, etc.), and the potential savings achievable by increased formulary compliance. A report(s) can be provided that shows the formulary dispensing rate by employment status (e.g., active, retired, etc.), and the potential savings achievable by increased formulary compliance, which can provide a comparison of the active, disabled, and retiree populations (and their dependents).

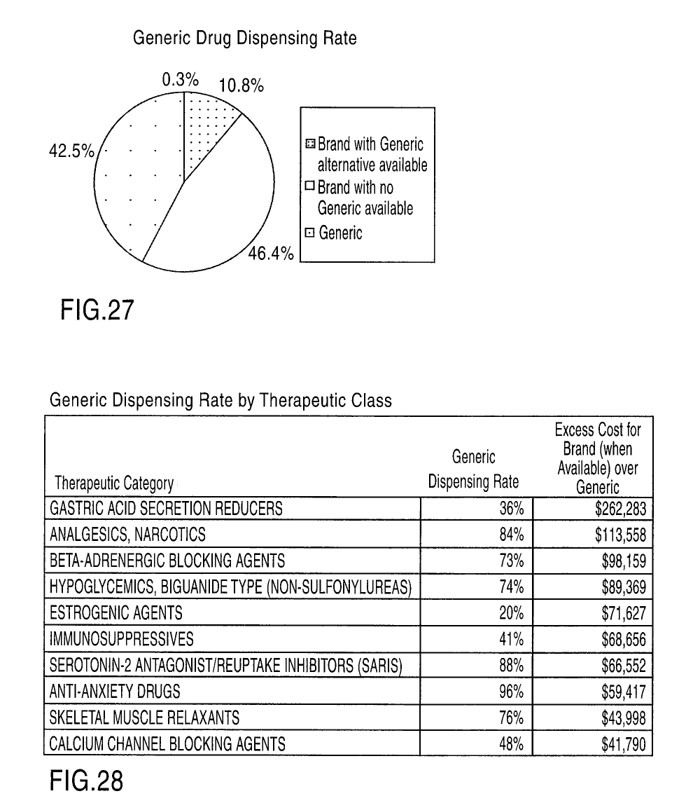

FIG. 27 is an example report that shows generic vs. brand dispensing rates. The gross potential savings can been calculated by converting all brand (when generic is available) to generic, at the generic unit cost. Another report can be provided that compares two periods of generic dispensing rates to provide trend information.

FIG. 28 is an example report that shows the top 10 therapeutic classes of drugs by excess of cost (for brand, when generic was available). This report provides an estimate of potential savings from increased generic substitution for branded drugs. Another report can be provided that shows the generic dispensing rate by MPC (e.g., psychiatry, gastroenterology, dermatology, etc.) for those MPC's having the greatest savings potential achieved by generic substitution, and can be used to determine if selected MPCs contribute disproportionately to the excess of cost.

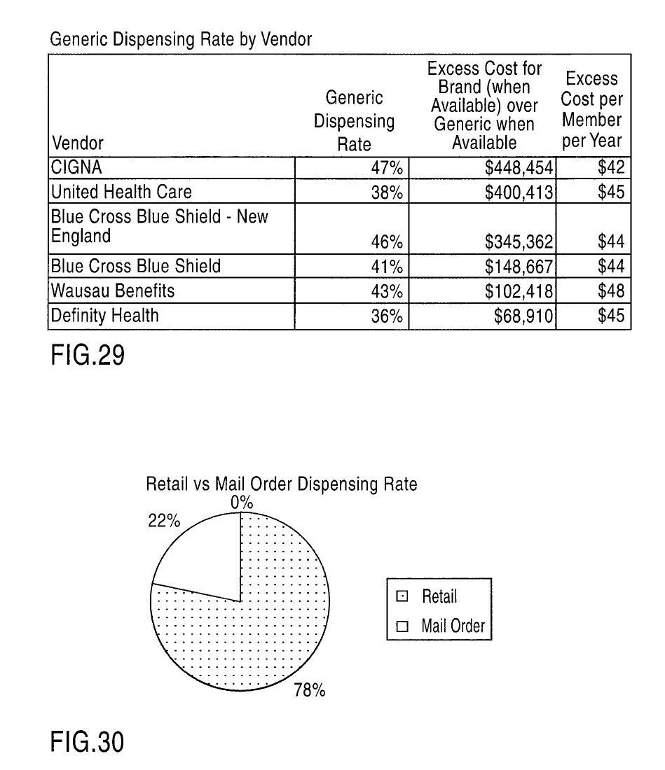

FIG. 29 is an example report that illustrates the generic dispensing rate by medical plan vendor, and the potential savings achievable by increased generic substitution. Other reports can provide the generic dispensing rate by business unit (e.g., sales and marketing, manufacturing, operations, etc.), and/or the generic dispensing rate by employment status (active, retired, etc.), and the potential savings achievable by increased generic substitution for each.

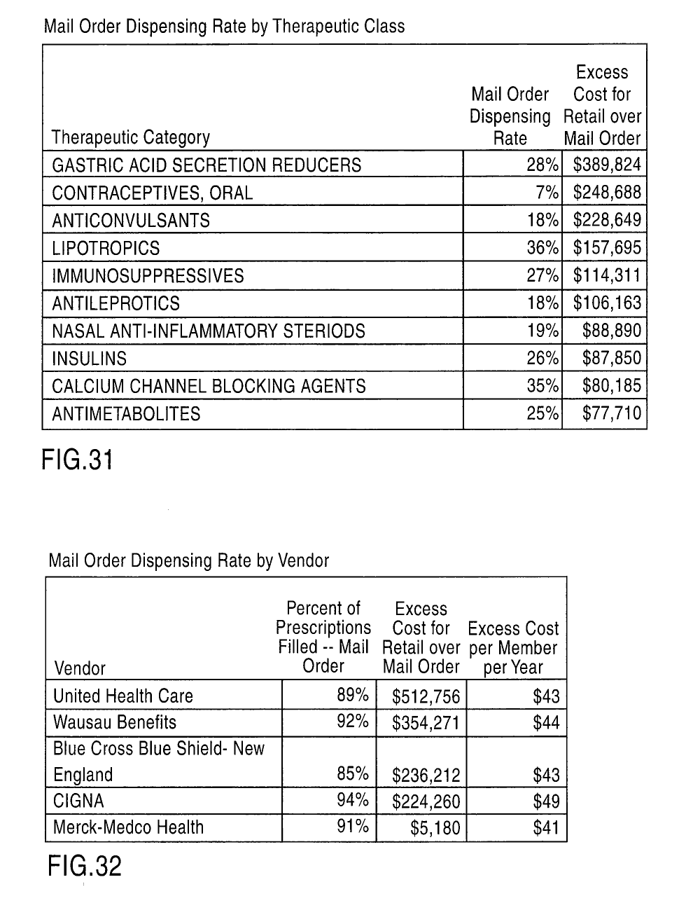

FIG. 30 illustrates an example report that shows retail vs. mail order dispensing rates. Reports providing retail and mail order rates over multiple time periods can also be provided. Another related report, as illustrated in FIG. 31 shows the top 10 by therapeutic classes of drugs by excess of cost (for retail over mail order). This report provides an estimate of potential savings that can be achieved by increased mail order substitution for refill drugs. A report that shows the mail order dispensing rate by MPC can also be provided.

A report showing the mail order dispensing rate by medical plan vendor can be provided, as shown in the example report of FIG. 32, which can provide information as to potential savings achievable by mail order substitution. Other reports showing the mail order dispensing rate by business unit, or the mail order dispensing rate by employment status, can also be provided.

With the Pharmacy Analytics Module an entity can, for example:
Compare recent distribution channel usage of prescription drugs against longer-term trends;
Review the use of distribution channels by demographic factors;
Identify usage patterns across vendors, plans, or business units;
Trace such changes to changes in plan design or pricing;
Identify opportunities to increase the utilization of preferred distribution channels; and
Estimate the expected impact on healthcare expenditures for prescription drugs.

A system and method according to an embodiment of the invention can also include the Dental Plan Analytics Module, which can be used to enable a user to identify trends in dental costs and utilization across various plans. A processor can receive electronic data representing information associated with multiple individuals within benefit plans during a pre-selected time period and receive electronic data representing information associated with multiple claims under a benefit plan for the same pre-selected time period. The processor can also provide electronic links to the user to access the product and run reports of similar metrics along various pre-determined dimensions with values (“filters”) designated by the user.

Data can be received that is associated with the entity including data associated with a change of enrollment for all vendors' offerings of a dental benefits plan of the entity. The processor can then calculate the change in enrollment and compare recent enrollment changes against long-term trends; identify the demographic changes and clinical conditions in enrollment; identify migration patterns across offerings and employment conditions; and trace such change to revisions in plan design or pricing. The processor can also be configured to estimate a cost impact associated with the change in enrollment along several dimensions associated with the benefits, including but not limited to offerings such as 1) vendors, plan types, health plans, or coverage tiers; 2) employment conditions such as business unit, employment status, exempt status, or union affiliation; and 3) demographics such as gender, age, or dependency. Reports can also be generated that are associated with out of plan services rendered under a dental benefit's plan, and the data can be used by an entity in the same manner as described above in other embodiments. As with the previous embodiments, various reports associated with dental benefits and claims can be automatically transmitted to an entity at a predetermined time period associated with a benefit or finance cycle of the entity.

A system and method according to an embodiment of the invention can also include the Vision Plan Analytics Module, which can provide data and reports associated with vision costs and utilization across vision plan membership. A processor can receive electronic data representing information associated with multiple individuals/members enrolled within benefit plans during a pre-selected time period and receive electronic data representing information associated with a plurality of claims under a benefit plan for the same pre-selected time period. The processor can also provide electronic links to the user to access the product and run reports of similar metrics along various pre-determined dimensions with values (“filters”) of the user's choice.

In some embodiments, a processor can be configured to receive data associated with a change of enrollment for all vendors' offerings of a vision benefits plan of the entity. The processor can be configured to calculate a change in enrollment and compare recent enrollment changes against long-term trends; identify the demographic changes and clinical conditions in enrollment; identify migration patterns across offerings and employment conditions; and trace such change to revisions in plan design or pricing. The processor can also be configured to estimate a cost impact associated with the change in enrollment along several dimensions associated with the benefits, including but not limited to offerings such as 1) vendors, plan types, health plans, or coverage tiers; 2) employment conditions such as business unit, employment status, exempt status, or union affiliation; and 3) demographics such as gender, age, or dependency. Reports can also be generated that are associated with out of plan services rendered under a vision benefit's plan, and the data can be used by an entity in the same manner as described above in other embodiments. As with the previous embodiments, various reports associated with vision benefits and claims can be automatically transmitted to an entity at a predetermined time period associated with a benefit or finance cycle of the entity.

A system and method according to an embodiment of the invention can also include the Disability Plan Analytics Module can help a user identify opportunities to reduce absence and promote return to work. A processor can receive electronic data representing information associated with multiple individuals/members enrolled within benefit plans during a pre-selected time period and receive electronic data representing information associated with a plurality of claims under a benefit plan for the same pre-selected time period. The processor can also provide electronic links to the user to access the product and run reports of similar metrics along various pre-determined dimensions with values (“filters”) of the user's choice.

In some embodiments, this module can receive data associated with a change of enrollment for all vendors' offerings of a disability benefits plan of the entity. The processor can then be configured to calculate the change in enrollment and to compare recent enrollment changes against long-term trends; identify the demographic changes and clinical conditions in enrollment; identify migration patterns across offerings and employment conditions; and trace such change to revisions in plan design or pricing. The processor can also be configured to estimate a cost impact associated with the change in enrollment along several dimensions associated with the benefits, including but not limited to offerings such as 1) vendors, plan types, or health plans; 2) employment conditions such as business unit, employment status, exempt status, or union affiliation; and 3) demographics such as gender or age. Reports can also be generated that are associated with out of plan services rendered under a disability benefit's plan, and the data can be used by an entity in the same manner as described above in other embodiments. As with the previous embodiments, various other reports associated with disability benefits can be automatically transmitted to an entity at a predetermined time period associated with a benefit or finance cycle of the entity.

A system and method according to an embodiment of the invention can also include the Workers' Compensation Plan Analytics Module, which can be used to identify opportunities to reduce absence and promote workplace safety. A processor can receive electronic data representing information associated with multiple claims under a benefit plan for the same pre-selected time period. The processor can also provide electronic links to the user to access the product and run reports of similar metrics along various pre-determined dimensions with values (“filters”) of the user's choice. Reports can also be generated that are associated with out of plan services rendered under a workmen's compensation plan, and the data can be used by an entity in the same manner as described above in other embodiments. As with the previous embodiments, various other reports associated with workers' compensation claims and benefits can be automatically transmitted to an entity at a predetermined time period associated with a benefit or finance cycle of the entity.

A system and method according to an embodiment of the invention can also include the Employee Contribution Analytics Module, which can help a user identify trends and cost-share differentials between employer and employee associated with, for example, medical, pharmacy and dental plans. Data can be received that is associated with, for example, employee contributions, employee cost shares, and employer cost shares for healthcare services under a health benefits plan. The processor can identify cost differentials in employee contributions across vendors, option types, and health plans. The processor can also calculate the relative contributions to healthcare costs of employee contributions versus employee cost share (e.g., co-payments and co-insurance), and categorize cost differentials along several dimensions associated with the benefits, including but not limited to 1) employment conditions such as business unit, employment status, exempt status, or union affiliation; and 2) demographics such as gender or age; and clinical conditions; and evaluate the adequacy of employee contributions for plan offerings during the coming plan year. As with the previous embodiments, various reports associated with employee contributions analytics can be automatically transmitted to an entity at a predetermined time period associated with a benefit or finance cycle of the entity.

A system and method according to an embodiment of the invention can include the Benefit Modeling and Pricing Module, which can be used to model potential changes in plan design and pricing and to forecast the impact of enrollment and utilization on employer cost. Data can be received that is associated with employer payments for healthcare claims under a health benefit plan. The processor can be configured to 1) forecast claims costs to the employer in, for example, dollars per member per month (PMPM) for a subsequent plan year with a default or user-selectable inflation factor; and/or 2) add to the forecasted claims cost, a factor of administrative expenses. As with the previous embodiments, various reports associated with pricing of benefits plans can be automatically transmitted to an entity at a predetermined time period associated with a benefit or finance cycle of the entity.

In another embodiment, Vendor Management Modules can be provided. As stated previously, the Vendor Management Modules provide measures of effectiveness to compare vendors, and consider provider or vendor improvements or replacements. Examples of Vendor Management Modules include a Health Risk Profile Module, a Best Practice Compliance Profile Module, a Pharmacy Vendor Analytic Module, and a Disability Vendor Analytics Module.

Individuals within a population have varying needs for health care services based on their illness burden (morbidity), age, and gender. The Health Risk Profile Module provides insight on the degree of financial risk associated with your population, cost drivers by service location, gaps in preventive practices, and prediction of future financial risk. With this automatic comparison, reporting, and alert system, employers are able to identify and then develop the right solutions for the actionable health conditions that drive the majority of the costs.

Data can be received that is associated with a health risk profile and a processor can be configured to calculate the degree of clinical and financial risk with numerical scores for a population in terms of resource utilization band, illness burden (co-morbidity ratio), efficiency index, or predicted risk index. The processor can also categorize profile health risk along several dimensions associated with the benefits, including but not limited to offerings such as 1) vendors, plan types, or health plans; 2) employment conditions such as business unit, employment status, exempt status, or union affiliation; 3) demographics such as gender, age, or dependency; and 4) clinical conditions such as disease/stage, condition group, enhanced diagnosis cluster, adjusted clinical condition, or episode treatment group. The processor can also estimate the potential savings from more appropriate medical interventions, initiatives, and programs. Reports associated with this module can be generated and transmitted to an entity in the same manner as previously described for other embodiments.

For many conditions, there are established or widely accepted “best practice” management protocols. These protocols include both medical tests and prescriptive drug therapies. The Best Practice Compliance Profile Module provides automatic comparison, reporting, and alerts, so that an employer can identify gaps that may exist between actual and expected performance and provide an opportunity to potentially improve the quality of care, improve health outcome, to decrease utilization of expensive healthcare services and ultimately to reduce costs. A processor can calculate and report on a shortfall, if any, with respect to various benchmarks, calculate the cost of non-compliance, and estimate the potential savings from improved compliance.

The various reports that can be generated by this module can, for example, help an entity identify opportunities for improved efficiency, identify gaps between actual and expected performance, and identify possible improvements in healthcare quality or outcomes. The entity can use the information to try to decrease utilization of ineffective, expensive healthcare services; and make appropriate interventions, initiatives, and programs to reduce costs. This module can also provide reports that categorize compliance along several dimensions associated with the benefits, including but not limited to, offerings such as 1) vendors, plan types, or health plans; 2) employment conditions such as business unit, employment status, exempt status, or union affiliation; 3) demographics such as gender, age, or dependency; and 4) clinical conditions such as disease/stage, condition group, enhanced diagnosis cluster, adjusted clinical condition, or episode treatment group. Reports associated with this module can be generated and transmitted to an entity in the same manner as previously described for other embodiments.

The Pharmacy Vendor Analytics Module enables a user to array comparable pharmacy unit cost of prescriptions. The Disability Vendor Analytics Module enables a user to differentiate the delivery and demand for disability services, and provides analytics to monitor the efficacy of disability vendors in adjudicating claims. Reports associated with this module can be generated and transmitted to an entity in the same manner as previously described for other embodiments.

As stated previously, financial management personnel typically record estimates of costs for the company's internal and external constituents. The Financial Management Module can include modules such as, a Claims and Enrollment Review Module, a provider Payment Reviewer Module, a Vendor Invoice Validator Module. These modules are more particularly described in U.S. patent application Ser. No. 11/253,803, which is incorporated herein.

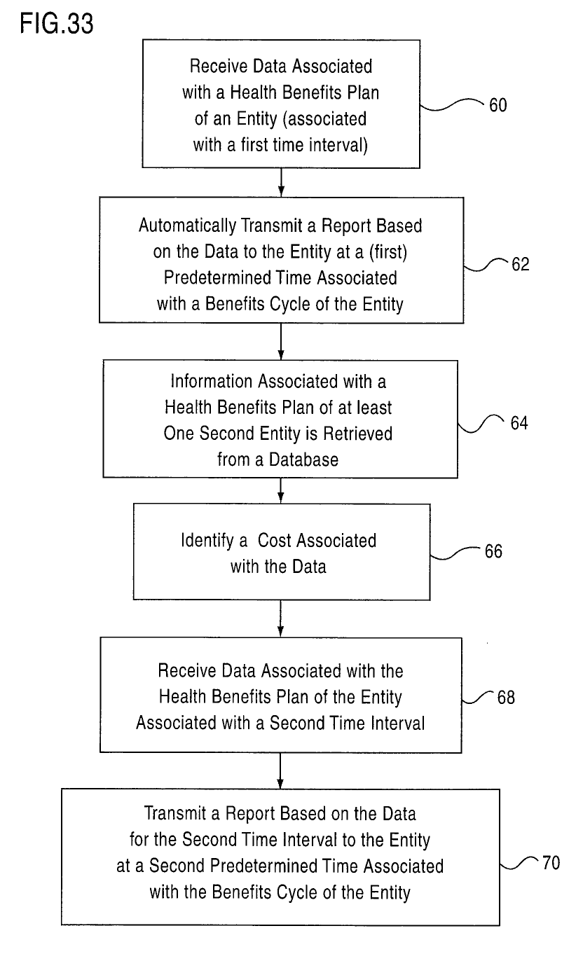

A method according to an embodiment of the invention is illustrated in a flowchart in FIG. 33. A method includes receiving data associated with a health benefits plan of an entity, 60. A report is automatically transmitted based on the data received to the entity at a predetermined time, 62. The predetermined time is associated with a benefits cycle of the entity and the report is associated with at least one feature of the health benefits plan of the entity. The report can be generated, for example, based on data associated with a plurality of vendors. The report can, in some embodiments, include data associated with a plurality of different dimensions associated with the benefits plan. In some embodiments, the report includes data identifying opportunities to reduce cost or utilization across a plurality of dimensions associated with the benefits plan.

In some embodiments, information associated with a health benefits plan of at least one second entity is retrieved from a database, 64. In such a case, the report can be automatically transmitted based on the data received associated with the health benefits plan of the first entity and the information retrieved associated with the health benefits plan of the second entity.

The data received can be associated with a variety of different variables, and a cost associated with the particular variable can be identified, 66. Examples of such variables include, for example, data associated with a change of enrollment for at least one member of the health benefits plan of the entity, data associated with a change of vendor selection for at least one member of the health benefits plan, data associated with a change in employment status of at least one member, and/or data associated with at least one member that includes a dependent and the associated vendor selection for the at least one member that includes a dependent. In some embodiments, the data associated with the health benefits plan of the entity includes data associated with an illness burden factor and an efficiency index associated with at least one vendor from a plurality of selectable vendors. In such an embodiment, a cost can be identified associated with the selection of at least one vendor based on the illness burden factor and the efficiency index associated with the at least one vendor.

In some embodiments, the data received from the entity is associated with a first time interval, and the predetermined time associated with a benefits cycle is a first predetermined time. In such an embodiment, at a second predetermined time data can be received that is associated with the health benefits plan of the entity, 68, and a report can be transmitted to the entity at a second predetermined time associated with the benefits cycle of the entity, 70. The report can be based on the data received from the entity associated with the second time interval. The benefit cycle can be for example, annual, quarterly, monthly, etc.

The modules and systems described herein can provide an employer or other entity with valuable information for managing and improving a health benefits plan provided for its employees. A variety of different data can be received that is associated with multiple aims submitted under a health benefits plan for an entity. Various reports can be generated and automatically provided or transmitted to an entity using push technology as described above. As discussed above with reference to specific example embodiments, the reports can include, for example, the effectiveness of services delivered to members by vendors and providers from the multiple claims; and opportunities for improving the services delivered by and to members by vendors and providers, while containing healthcare cost.

In some embodiments, a processor can be configured, for example, to compare costs of prescriptions across providers (pharmacies) and against established norms; confirm that vendors are appropriately crediting clients for rebates obtained; and estimate the potential savings from more efficient pharmacy purchasing initiatives and programs. The processor can also be configured to differentiate between the delivery of and the demand for disability services; compare the costs of disability services across providers and against established norms; and estimate the potential savings from more efficient disability interventions, initiatives, and programs.

### CONCLUSION

While various embodiments of the invention have been described above, it should be understood that they have been presented by way of example only, and not limitation. Thus, the breadth and scope of the invention should not be limited by any of the above-described embodiments, but should be defined only in accordance with the following claims and their equivalents. While the invention has been particularly shown and described with reference to specific embodiments thereof, it will be understood that various changes in form and details may be made.

For example, the reports described herein with reference to specific embodiments are only some examples of the various types of reports and information that can be calculated, compared, estimated, reported, etc., according to embodiments of the invention. Some embodiments can include a processor configured to perform only some of the functions described herein, while other embodiments can include a processor configured to perform all of the functions described herein.

In addition, although the description describes receiving data via electronic means, it should be understood that other means of receiving data can be used. For example, hard copies of data can be manually input into a server by methods such as, for example, keyboard inputs and/or scanning. Such data can be transmitted or sent in hard copy format through standard mailing systems (e.g., U.S. Postal Service, United Parcel Service (UPS), FedEx, etc.). Likewise, reports (e.g., alerts) according to embodiments of the invention can be sent by these same means rather than electronically.

What is claimed is:

1. A processor-readable medium storing code representing instructions to cause a processor to perform a process, the code comprising code to:
receive data associated with a health benefits plan of an entity; and
automatically transmit to the entity at a predetermined time a report based on the data received, the predetermined time being associated with a repetitive business practice within a benefits cycle of the entity, the report associated with at least one feature of the health benefits plan of the entity.

2. The processor-readable medium of claim 1, wherein the report is generated based on data associated with a plurality of vendors.

3. The processor-readable medium of claim 1, wherein the report includes data associated with a plurality of different dimensions associated with the benefits plan.

4. The processor-readable medium of claim 1, wherein the report includes data identifying opportunities to reduce cost or utilization across a plurality of dimensions associated with the benefits plan.

5. The processor-readable medium of claim 1, the entity being a first entity, the code further comprising code to:
retrieve from a database information associated with a health benefits plan of at least one second entity; and
automatically transmit the report based on the data received associated with the health benefits plan of the first entity and the information retrieved associated with the health benefits plan of the second entity.

6. The processor-readable medium of claim 1, wherein the data received from the entity is associated with a first time interval, the predetermined time associated with a benefits cycle is a first predetermined time, the processor-readable medium further comprising code to:
receive data associated with the health benefits plan of the entity associated with a second time interval; and
automatically transmit a report to the entity at a second predetermined time associated with the benefits cycle of the entity, the report based on the data received from the entity associated with the second time interval.

7. The processor-readable medium of claim 1, wherein the benefit cycle is an annual benefit cycle.

8. A method, comprising:
receiving data associated with a health benefits plan of an entity; and
automatically transmit a report based on the data received to the entity at a predetermined time, the predetermined time being associated with a repetitive business practice within a benefits cycle of the entity, the report associated with at least one feature of the health benefits plan of the entity.

9. The method of claim 8, wherein the report is generated based on data associated with a plurality of vendors.

10. The method of claim 8, wherein the report includes data associated with a plurality of dimensions associated with the benefits plan.

11. The method of claim 8, wherein the reports includes data identifying opportunities to reduce cost or utilization across a plurality of dimensions associated with the benefits plan.

12. The method of claim 8, the entity being a first entity, the method further comprising:
retrieving from a database information associated with a health benefits plan of at least one second entity; and
automatically transmitting the report based on the data received associated with the health benefits plan of the first entity and the information retrieved associated with the health benefits plan of the second entity.

13. The method of claim 8, wherein the data received from the entity is associated with a first time interval, the predetermined time associated with a benefits cycle is a first predetermined time, the method further comprising:
receiving data associated with the health benefits plan of the entity associated with a second time interval; and
automatically transmitting a report to the entity at a second predetermined time associated with the benefits cycle of the entity, the report based on the data received from the entity associated with the second time interval.

14. The method of claim 8, wherein the benefit cycle is an annual benefit cycle.

15. A processor-readable medium storing code representing instructions to cause a processor to perform a process, the code comprising code to:
receive a first data set associated with a first time interval of a health benefits plan of an entity;
automatically transmit a first report based on the first data set to the entity at a predetermined first time period associated with a benefits cycle of the entity, the report associated with at least one feature of the health benefits plan of the entity;
receive a second data set associated with a second time interval of the health benefits plan of the entity, the second time interval being after the first time interval; and
automatically transmit a second report to the entity at a predetermined second time period associated with the benefits cycle of the entity, the second time period being after the first time period, the second report being based on the second data set.

16. The processor-readable medium of claim 15, wherein the benefit cycle of the entity is annual.

17. The processor-readable medium of claim 15, wherein the first data set includes costs data associated with a plurality of different vendors.

18. The processor-readable medium of claim 15, further comprising code to:
receive a third data set associated with a first time interval of a health benefits plan of a second entity; and
generate a report based on the first data set and the third data set.

19. The processor-readable medium of claim 15, wherein the first report includes data to identify opportunities to reduce cost or utilization across a plurality of dimensions associated with the benefits plan.

20. The processor-readable medium of claim 15, wherein the first report includes data associated with a plurality of dimensions associated with the benefits plan.
